(19) United States
(12) Patent Application Publication
(10) Pub. No.: US 2012/0253789 A1
(43) Pub. Date: Oct. 4, 2012

(54) Conversational Dialog Learning and Correction

(75) Inventors: Larry Paul Heck, Los Altos, CA (US); Madhusudan Chinthakunta, Saratoga, CA (US); David Mitby, Mountain View, CA (US); Lisa Stifelman, Palo Alto, CA (US)

(73) Assignee: Microsoft Corporation, Redmond, WA (US)

(21) Appl. No.: 13/077,233

(22) Filed: Mar. 31, 2011

(51) Int. Cl. G06F 17/27

(52) U.S. Cl. 704/9; 704/E11.001

(57) ABSTRACT

Conversational dialog learning and correction may be provided. Upon receiving a natural language phrase from a first user, at least one second user associated with the natural language phrase may be identified. A context state may be created according to the first user and the at least one second user. The natural language phrase may then be translated into an agent action according to the context state.

### RELATED APPLICATIONS

This patent application is also related to and filed concurrently with U.S. patent application Ser. No. ______, entitled “Augmented Conversational Understanding Agent,” bearing attorney docket number 14917.1628US01/MS331057.01; U.S. patent application Ser. No. ______, entitled “Personalization of Queries, Conversations, and Searches,” bearing attorney docket number 14917.1634US01/MS331155.01; U.S. patent application Ser. No. ______, entitled “Combined Activation for Natural User Interface Systems,” bearing attorney docket number 14917.1635US01/MS331157.01; U.S. patent application Ser. No. ______, entitled “Task Driven User Intents,” bearing attorney docket number 14917.1636US01/MS331158.01; U.S. patent application Ser. No. ______, entitled “Augmented Conversational Understanding Architecture,” bearing attorney docket number 14917.1649US01/MS331339.01; U.S. patent application Ser. No. ______, entitled “Location-Based Conversational Understanding,” bearing attorney docket number 14917.1650US01/MS331340.01; which are assigned to the same assignee as the present application and expressly incorporated herein, in their entirety, by reference.

### BACKGROUND

Conversational dialog learning and correction may provide a mechanism for facilitating natural language understanding of user queries and conversations. Conventional speech recognition applications and techniques do not provide good mechanisms for learning and personalizing the speech patterns of a particular user or the particular speech patterns of a user's conversations with other users. For instance, when user 1 has a voice conversation with user 2, a particular speech pattern may be used, which may be different from the speech pattern used when user 1 has a voice conversation with user 3. Furthermore, current speech recognition systems have little ability to learn speech dynamically on the fly from the user and also to learn about how different people have conversations with each other. For example, if the user says a word that the speech recognition system associates with another word and/or another meaning of the correct word, the user has no mechanism to concurrently correct the system's interpretation of the spoken word and allow the system to “learn” the word in the particular context in which the word is.

Speech-to-text conversion (i.e., speech recognition) may comprise converting a spoken phrase into a text phrase that may be processed by a computing system. Acoustic modeling and/or language modeling may be used in modern statistic-based speech recognition algorithms. Hidden Markov models (HMMs) are widely used in many conventional systems. HMMs may comprise statistical models that may output a sequence of symbols or quantities. HMMs may be used in speech recognition because a speech signal may be viewed as a piecewise stationary signal or a short-time stationary signal. In a short-time (e.g., 10 milliseconds), speech may be approximated as a stationary process. Speech may thus be thought of as a Markov model for many stochastic purposes.

### SUMMARY

This summary is provided to introduce a selection of concepts in a simplified form that are further described below in the detailed description. This summary is not intended to identify key features or essential features of the claimed subject matter. Nor is this summary intended to be used to limit the claimed subject matter's scope.

Conversational dialog learning and correction may be provided. Upon receiving a natural language phrase from a first user, at least one second user associated with the natural language phrase may be identified. A context state may be created according to the first user and the at least one second user. The natural language phrase may then be translated into an agent action according to the context state.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIGS. 2A-C are block diagrams of an interface for providing conversational learning and correction;

FIG. 3 is a flow chart of a method for providing conversational learning and correction; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Conversational learning and correction may be provided. A natural language speech recognition system may provide the ability to personalize speech recognition patterns from a particular user or between particular users in a conversation. The system also may learn the speech patterns through corrective interaction with the user. Consequently, with a more personalized understanding of the user's speech patterns and context, the system is able to provide more accurate results of speech queries and in personal assistant systems to provide more pertinent information in response to speech conversations between users or between user and machines.

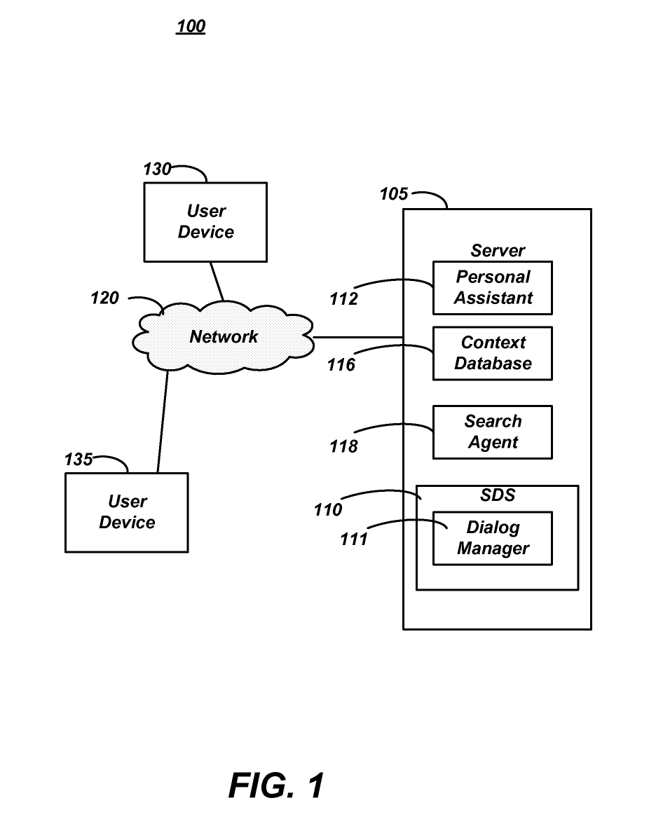

FIG. 1 is a block diagram of an operating environment 100 comprising a server 105. Server 105 may comprise assorted computing resources and/or software modules such as a spoken dialog system (SDS) 110 comprising a dialog manager 111, a personal assistant program 112, a context database 116, and/or a search agent 118. Server 105 may receive queries and/or action requests from users over network 120. Such queries may be transmitted, for example, from a first user device 130 and/or a second user device 135 such as a computer and/or cellular phone. Network 120 may comprise, for example, a private network, a cellular data network, and/or a public network such as the Internet.

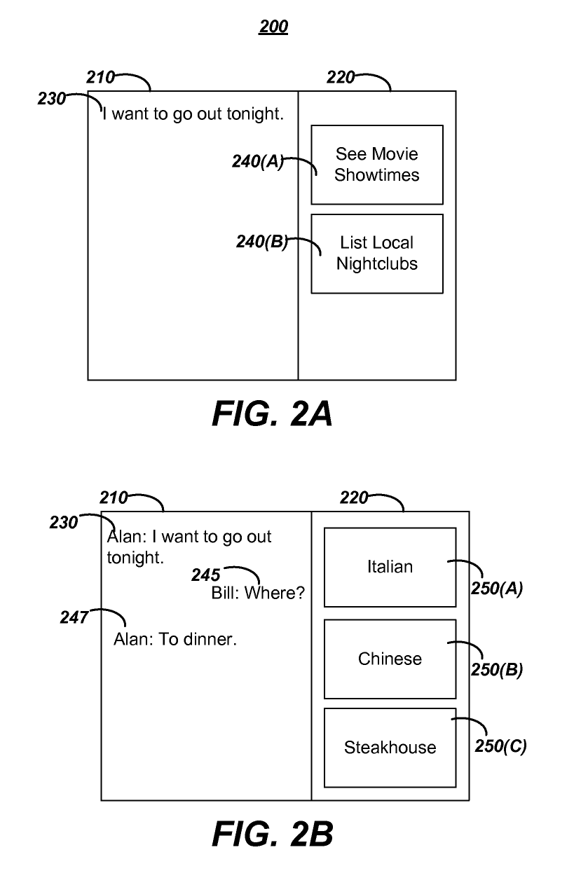

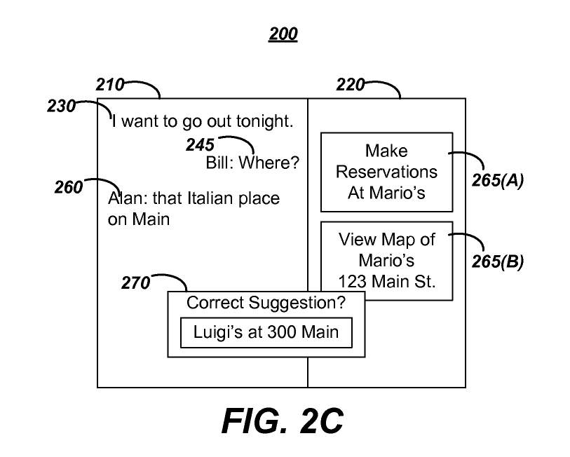

FIG. 2A is a block diagram of an interface 200 for providing conversational learning and correction. Interface 200 may comprise a user input panel 210 and a personal assistant panel 220. User input panel 210 may display converted user queries and/or action requests such as a user statement 230. User statement 230 may comprise, for example, a result from a speech-to-text conversion received from a user of user device 130. Personal assistant panel 220 may comprise a plurality of action suggestions 240(A)-(B) derived from a context state associated with the user and user statement 230. Consistent with embodiments of the invention, the context state may take into account any other participants in the conversation, such as a user of second user device 135, who may have heard the speaking of user statement 230. Personal assistant program 112 may thus monitor a conversation and offer action suggestions 240(A)-(B) to the user of first user device 130 and/or second user device 135 without being an active participant in the conversation.

FIG. 2B is a further illustration of interface 200 comprising an updated display after a user provides an update to user statement 230. For example, a question 245 from a user of second user device 135 and a response 247 from the user of first user device 130 may cause personal assistant program 112 to update the context state and provide a second plurality of action suggestions 250(A)-(C). For example, second plurality of action suggestions 250(A)-(C) may comprise different suggested cuisines that the user may want to eat. Consistent with embodiments of the invention, the agent may learn to associate such updates with conversations between these two users and may remember them for use in future conversations.

FIG. 2C is an illustration of interface 200 comprising a correction to an agent action. For example, a second user statement 260 of “that Italian place on Main” may be translated by the agent to refer to a restaurant named “Mario's” at 123 Main St. Third plurality of action suggestions 265(A)-(B) may be displayed comprising actions related to Mario's, but the user may have intended a different restaurant, “Luigi's” at 300 Main St. The user may interact with personal assistant program 112, through interface 200 and/or via another input method, such as a voice command, to provide a correction. For example, the user may right click one of the actions and select a displayed menu item for correcting the action or the user may say “correction” to bring up a correction window 270. The user may then provide the correct interpretation for any of the previous statements, such as by entering that the Italian place on Main refers to Luigi's.

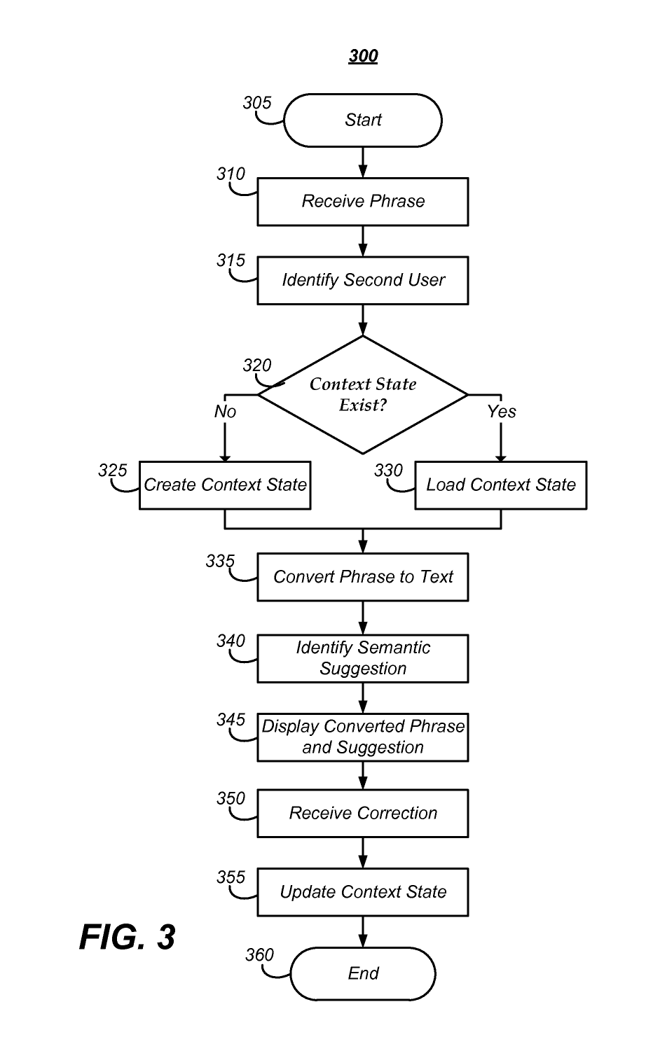

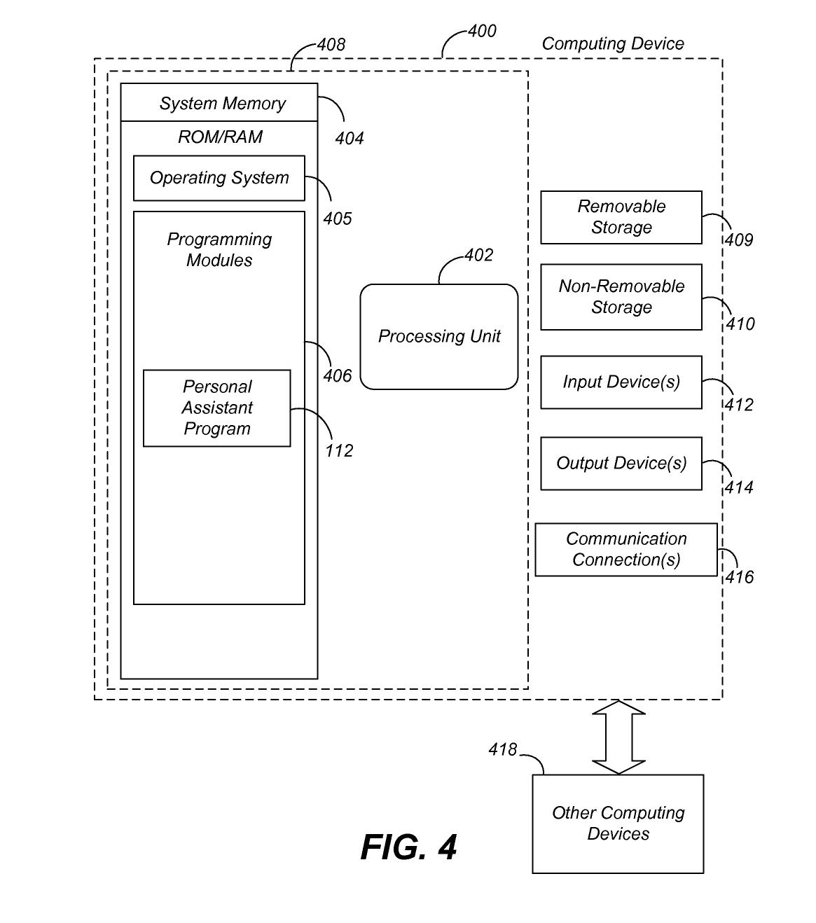

FIG. 3 is a flow chart setting forth the general stages involved in a method 200 consistent with an embodiment of the invention for providing can ERP context-aware environment. Method 300 may be implemented using a computing device 400 as described in more detail below with respect to FIG. 4. Ways to implement the stages of method 300 will be described in greater detail below. Method 300 may begin at starting block 305 and proceed to stage 310 where computing device 400 may receive a spoken natural language phrase from a first user. For example, a first user of first user device 130 may say “Let's go out tonight.” This phrase may be captured by first user device 130 and shared with personal assistant program 112.

Method 300 may then advance to stage 315 where computing device 400 may identify at least one second user to whom the spoken natural language phrase is addressed. For example, the first user may be involved in a conversation with a second user. The first user and the second user may both be in range to be heard by first user device 130 and/or may be involved in a conversation via respective first user device 130 and second user device 135, such as cellular phones. Personal assistant program 112 may listen in on the conversation and identify the second user and that user's relationship to the first user (e.g., a personal friend, a work colleague, a spouse, etc.).

Method 300 may then advance to stage 320 where computing device 400 may determine whether a context state associated with the first user and the second user exists. For example, server 105 may determine whether a context state associated with the two users is stored in context database 116. Such a context state may comprise details of previous interactions between the two users, such as prior meetings, communications, speech habits, and/or preferences.

If the context state does not exist, method 300 may advance to stage 325 where computing device 400 may create the context state according to at least one characteristic associated with the at least one second user. For example, a context state comprising data that the second user is the first user's boss may be created.

If the context state does exist, method 300 may advance to stage 315 where computing device 400 may load the context state. For example, personal assistant program 112 may load the context state from context database 116.

After creating the context state at stage 325 or loading the context state at stage 330, method 300 may advance to stage 335 where computing device 400 may convert the spoken natural language phrase into a text-based natural language phrase according to the context state. For example, server 105 may perform a speech-to-text conversion on the spoken phrase and/or translate the natural language phrase into context-dependent syntax. If first user's phrase comprises “He was a great rain man” while talking to a co-worker, the query server may translate the meaning as referring to someone who brings in lots of business. If the same phrase is spoken to a friend with whom the user enjoys seeing movies, however, the query server may translate the meaning as referring to the Dustin Hoffman movie “Rain Man”.

Method 300 may then advance to stage 340 where computing device 400 may identify at least one agent action associated with the text-based natural language phrase. The agent action may comprise, for example, providing a hypertext link, a visual image, at least one additional text word, and/or a suggested action to the user. The agent action may also comprise an executed action, such as a call to a network based application, to perform some task associated with the phrase. Where first user is speaking to a work colleague about someone who brings in business, a suggested action of contacting the “rain man” in question may be identified. When referring to the movie, a hypertext link to a website about the movie may instead be identified.

Method 300 may then advance to stage 345 where computing device 400 may display the text-based natural language phrase and the at least one semantic suggestion to the first user. For example, the converted phrase may be displayed in user input panel 210 and the suggested action and/or hyperlink may be displayed in personal assistant panel 220.

Method 300 may then advance to stage 350 where computing device 400 may receive a correction from the first user. For example, the user may select one and/or more words of the conversation and provide a change to a corrected conversion. For another example, the user may correct the at least one term such as where the user's phrase was “the Italian place on Main”, and personal assistant program 112 identified the wrong restaurant and the user selects the intended one.

Method 300 may then advance to stage 355 where computing device 400 may update the context state according to the received correction. For example, where the user corrects which restaurant is meant by “the Italian place on 10^{th}”, the correction may be stored as part of the context state and remembered the next time the user makes such a reference. Method 300 may then end at stage 360.

An embodiment consistent with the invention may comprise a system for providing a context-aware environment. The system may comprise a memory storage and a processing unit coupled to the memory storage. The processing unit may be operative to receive a natural language phrase from a first user, identify at least one second user associated with the natural language phrase, create a context state according to the first user and the at least one second user, translate the natural language phrase into an agent action according to the context state, display the agent action to the user, receive a correction to the agent action from the user, and update the context state according to the received correction. The correction may be received during normal operation of the agent and/or while the agent is operating in a learning mode. For example, the user may invoke the learning mode by specifying an intent to perform a specific action, such as booking an airline ticket. The agent may then learn certain user preferences (e.g., preferred airline, type of seat, travel time). The natural language phrase may be received as a text phrase and/or a spoken phrase. The processing unit may be further operative to display the agent action to the first user, determine whether the first user authorizes performing the agent action, and, if so, performing the agent action. The processing unit may then be operative to display a result of performing the action to the first user and/or the second user. Rather than wait for authorization, the processing unit may be operative to automatically perform the agent action and displaying a result associated with performing the agent action to the first user and/or the second user.

Upon receiving the same natural language phrase from the first user, the processing unit may be operative identifying at least one third (e.g., different) user associated with the natural language phrase, create a second context state according to the first user and the at least one third user, and translate the natural language phrase into a second agent action according to the context state. For example, the second user may comprise a work contact of the first user and the third user may comprise a personal contact of the first user.

Another embodiment consistent with the invention may comprise a system for providing a context-aware environment. The system may comprise a memory storage and a processing unit coupled to the memory storage. The processing unit may be operative to establish a context state associated with a first user and a second user, receive a spoken natural language phrase from the first user, convert the spoken natural language phrase into a text-based natural language phrase, display the text-based natural language phrase to the first user, receive a correction to the text-based natural language phrase, and update the context state associated with the first user and the second user. The text-based natural language phrase may comprise at least one semantic suggestion such as a hypertext link, a visual image, and/or a suggested action. The processing unit may be operative to execute the suggested action and display a result associated with executing the suggested action to the first user. The correction may comprise, for example, a correction to the semantic suggestion and/or a correction associated with the conversion from the spoken natural language phrase to the text-based natural language phrase. Consistent with embodiments of the invention, the correction may comprise adding and/or changing a meaning of a term in the phrase. For example, a phrase comprising “my band” may be used to associate that term with a name, description, and/or web page associated with a band in which the user plays, while the phrase “dolphins” may be associated with a team on which the user plays, rather than the professional team or the animals. The processing unit may be operative to store context states associated with conversations between specific users and load those states for subsequent conversations between the same users.

Yet another embodiment consistent with the invention may comprise a system for providing a context-aware environment. The system may comprise a memory storage and a processing unit coupled to the memory storage. The processing unit may be operative to receive a spoken natural language phrase from a first user, identify at least one second user to whom the spoken natural language phrase is addressed, and determine whether a context state associated with the first user and the second user exists in the memory storage. If not, the processing unit may be operative to create the context state according to at least one characteristic associated with the at least one second user. Otherwise, the processing unit may be operative to load the context state.

The processing unit may then be operative to convert the spoken natural language phrase into a text-based natural language phrase according to the context state, identify at least one agent action associated with the text-based natural language phrase, and display the text-based natural language phrase and the at least one semantic suggestion to the first user. The agent action may comprise, for example, a hypertext link, a visual image, at least one additional text word, and a suggested action. The processing unit may be operative to receive a correction from the first user and update the context state according to the received correction.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise operating environment 100 as described above. Operating environment 100 may comprise other components and is not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g., random access memory (RAM)), non-volatile (e.g., read-only memory (ROM)), flash memory, or any combination. System memory 404 may include operating system 405, one or more programming modules 406, and may include a certificate management module 407. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g., ERP application 420) may perform processes including, for example, one or more of method 300's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing conversational learning and correction, the method comprising:
receiving, by an agent, a natural language phrase from a first user;
identifying at least one second user associated with the natural language phrase;
creating a context state according to the first user and the at least one second user;
translating the natural language phrase into an agent action according to the context state;
displaying the agent action to the user;
receiving a correction to the agent action from the user; and
updating the context state according to the received correction.

2. The method of claim 1, wherein the correction is received while the agent is operating in a learning mode.

3. The method of claim 1, further comprising creating a base context state associated with the user while the agent is operating in a learning mode.

4. The method of claim 1, further comprising:
displaying the agent action to the first user;
determining whether the first user authorizes performing the agent action; and
in response to determining that the first user authorizes performing the agent action, performing the agent action.

5. The method of claim 4, further comprising updating the context state according to the authorization.

6. The method of claim 1, wherein the correction is associated with the translation of the natural language phrase.

7. The method of claim 1, wherein the agent action comprises a suggestion to the user.

8. The method of claim 1, further comprising:
receiving the natural language phrase from the first user;
identifying at least one third user associated with the natural language phrase;
creating a second context state according to the first user and the at least one third user; and
translating the natural language phrase into a second agent action according to the context state.

9. The method of claim 8, further comprising applying the received correction to the second context state.

10. A computer-readable medium which stores a set of instructions which when executed performs a method for providing conversational learning and correction, the method executed by the set of instructions comprising:
establishing a context state associated with a first user and a second user;
receiving a spoken natural language phrase from the first user;
converting the spoken natural language phrase into a text-based natural language phrase;
displaying the text-based natural language phrase to the first user;
receiving a correction to the text-based natural language phrase; and
updating the context state associated with the first user and the second user.

11. The computer-readable medium of claim 10, wherein the text-based natural language phrase comprises at least one agent action.

12. The computer-readable medium of claim 11, wherein the at least one agent action comprises displaying a suggested hypertext link.

13. The computer-readable medium of claim 11, wherein the at least one agent action comprises displaying a visual image.

14. The computer-readable medium of claim 11, wherein the at least one agent action comprises a suggested search action.

15. The computer-readable medium of claim 14, further comprising:
executing the suggested search action; and
displaying a result associated with executing the suggested search action to the first user.

16. The computer-readable medium of claim 11, wherein the correction is associated with the at least one agent action.

17. The computer-readable medium of claim 10, wherein the correction is associated with the conversion from the spoken natural language phrase to the text-based natural language phrase.

18. The computer-readable medium of claim 17, wherein the correction comprises an expansion of a shortcut word associated with the spoken natural language phrase.

19. The computer-readable medium of claim 18, further comprising:
storing the updated context state; and
loading the updated context state for a subsequent conversation between the first user and the second user.

20. A system for providing conversational learning and correction, the system comprising:
a memory storage; and
a processing unit coupled to the memory storage, wherein the processing unit is operative to:
receive a spoken natural language phrase from a first user,
identify at least one second user to whom the spoken natural language phrase is addressed,
determine whether a context state associated with the first user and the second user exists in the memory storage,
in response to determining that the context state does not exist in the memory storage, create the context state according to at least one characteristic associated with the at least one second user,
in response to determining that the context state exists in the memory storage, load the context state,
convert the spoken natural language phrase into a text-based natural language phrase according to the context state,
identify at least one semantic suggestion associated with the text-based natural language phrase, wherein the at least one semantic suggestion comprises at least one of the following: a hypertext link, a visual image, at least one additional text word, and a suggested action,
display the text-based natural language phrase and the at least one semantic suggestion to the first user,
receive a correction from the first user, wherein the correction is associated with at least one of the following: the text-based natural language phrase and the at least one semantic suggestion, and
update the context state according to the received correction.
